(19) United States
(12) Patent Application Publication
(10) Pub. No.: US 2020/0331471 A1
(43) Pub. Date: Oct. 22, 2020

(54) DRIVING ASSISTANCE APPARATUS AND ADJUSTMENT METHOD THEREOF

(71) Applicant: Toyota Jidosha Kabushiki Kaisha, Toyota-shi Aichi-ken (JP)

(72) Inventors: Takenoshin Takahashi, Toyota-shi (JP); Masami Nagano, Toyota-shi (JP)

(21) Appl. No.: 16/847,969

(22) Filed: Apr. 14, 2020

(30) Foreign Application Priority Data
Apr. 18, 2019 (JP) 2019-079445

(51) Int. Cl. B60W 30/095; B60W 60/00

(52) U.S. Cl. CPC B60W 30/0956; B60W 60/0015; B60W 2050/143; B60W 2554/404; B60W 2554/20

(57) ABSTRACT

A driving assistance apparatus of a vehicle includes a first sensor, a second sensor and a control unit. The first sensor obtains a position of an object with respect to the first sensor. The second sensor obtains a position of an object with respect to the vehicle. The control unit assists driving of the vehicle utilizing first vehicle relative position for an object detected by the first sensor which indicates a position of that object with respect to the vehicle. The control unit obtains the first vehicle relative position based on a correction angle formed between a reference axis of the vehicle and a reference axis of the first sensor. The correction angle is obtained based on a position of a target with respect to the first sensor obtained by the first sensor, and a position of the target with respect to the vehicle obtained by the second sensor.

### CROSS REFERENCE TO RELATED APPLICATIONS

This nonprovisional application claims priority to Japanese Patent Application No. 2019-079445 filed with the Japan Patent Office on Apr. 18, 2019, the entire contents of which are hereby incorporated by reference.

### TECHNICAL FIELD

The present disclosure relates to a driving assistance (support) apparatus configured to obtain (measure) a position of an object around a vehicle with respect to the vehicle utilizing a sensor device and to assist driving (travelling) of the vehicle on the basis of the position, and an adjusting method of/for the driving assistance apparatus.

### BACKGROUND

One conventionally known driving assistance apparatus of such a kind which is applied to a vehicle (hereinafter also referred to as the “conventional apparatus”) is equipped with a radar apparatus as a sensor device for obtaining a position of an object with respect to the vehicle. The radar apparatus obtains position data indicative of a position of an object with respect to the radar apparatus. This position data includes a combination of a distance between the radar apparatus and the object and an angle formed between “a straight line connecting the radar apparatus and the object” and “a sensor reference axis (main axis of a transmission direction of an electromagnetic wave).”

For example, in a case where a radar apparatus is utilized for obtaining a position of an object present in a front region (area) of the vehicle, the radar apparatus is disposed at the center of the front end of the vehicle in the lateral direction. However, if the sensor reference axis is not adjusted so as to be parallel to the vehicle longitudinal axis, the position data of an object obtained by the radar apparatus may be different from data indicative of a position of the object with respect to the vehicle.

Therefore, conventionally, an operation (a work) to adjust a mounting angle (attachment angle) of a radar apparatus to a vehicle has been performed so as to make the sensor reference axis parallel to the vehicle longitudinal axis passing through the center position in the lateral direction (width direction) of the vehicle (see, for example, Japanese Patent Application Laid-Open (kokai) No. 2007-240369).

### SUMMARY

n such an adjustment operation, an operator (a serviceman) has to place (dispose) “a target (object) including a radio wave reflector for axis direction adjustment” at a position (target placing position) on the vehicle longitudinal axis passing through the center position in the lateral direction of the vehicle. However, placing (positioning) the target for axis direction adjustment at the target placing position accurately is not easy, increases a load of the operator/servicemen, and/or lengthens a time required for the adjustment. Especially, if the radar apparatus is exchanged at a vehicle repair shop or a vehicle store that has little appropriate equipment unlike a vehicle production factory, this adjusting operation/work may impose a great burden on an operator/serviceman.

In view of the forgoing, one object of the present disclosure is to provide a driving assistance apparatus configured to be able to obtain an accurate position of an object with respect to a vehicle, even though an adjusting operation imposing a burden on an operator has not been performed, and also to provide an adjusting method for the driving assistance apparatus.

A driving assistance apparatus for achieving the above-described object (hereinafter also referred to as the “apparatus of the present disclosure”) comprises a first sensor device, a second sensor device, and a control unit. The control unit may be implemented by at least one programmed processor whose operation is determined by a predetermined program, gate arrays and the like.

The first sensor device (a radar apparatus 30) includes a first detecting section (a radar transmission section 31 and a radar reception section 32) placed at a predetermined first installation position (a radar base point Pr) of a vehicle (10), and is configured to obtain first position data (a radar object distance Dr and a radar object angle θr) indicative of a position of a first object (a radar detected object) with respect to the first detecting section. The first object is an object present in a first detection region (a radar detection region) around the vehicle, and the first position data includes a combination of a distance (the radar object distance Dr) between the first detecting section and the first object and an angle formed between a straight line connecting the first detecting section and the first object and a first sensor reference axis (a radar central axis Cr) extending from the first detecting section to a first predetermined direction.

The second sensor device (a camera apparatus 40 and an ECU 20) includes a second detecting section (an image obtaining section 41) placed at a predetermined second installation position (a camera base point Pc) of the vehicle, and is configured to obtain second vehicle relative position data (a longitudinal distance Dx and a lateral distance Dy obtained on the basis an expression (3) and an expression (4)) indicative of a position of a second object (a camera detected object) with respect to the vehicle. The second object is an object present in a second detection region (a camera detecting region) around the vehicle, and the second detection region includes an “overlapping detecting region” where the first detection region and the second detection region overlap each other.

The control unit (the ECU 20) is configured to assist driving of the vehicle utilizing first vehicle relative position data (a longitudinal distance Dx and a lateral distance Dy obtained on the basis an expression (1) and an expression (2)) indicative of the position of the first object with respect to the vehicle. The first vehicle relative position data is determined on the basis of the first position data obtained by the first sensor device.

In addition, the control unit is configured to start to execute “correction angle obtaining processing” (a routine shown in FIG. 6) to obtain an correction angle (Δθ) on the basis of a combination of the first position data (a position of a millimetric-wave target benchmark point Ptm) obtained by the first sensor device for a first target (a combined target 70) as a reference object and the second vehicle relative position data (a position of an optical target benchmark point Ptc) obtained by the second sensor device for the first target when it is determined that an operator performs a predetermined “correction angle obtainment starting operation (manipulation).” The correction angle is an angle formed between a vehicle reference axis (a vehicle reference axis and an x axis) defined based on the vehicle and the first sensor reference axis.

Furthermore, the control unit is configured to obtain the first vehicle relative position data for an object present in the first detection region on the basis of a combination of the first position data for that object obtained by the first sensor device and the correction angle obtained through the correction angle obtaining processing in a predetermined period (a period in which the vehicle 10 is in a drivable state) other than a period in which the correction angle obtaining processing is being executed.

In other words, a method of the apparatus of the present disclosure comprises a first target placing step, a correction angle obtaining step, and a correction angle storing step.

The first target placing step is a step for placing the first target at a position (reference position) in the overlapped detecting region.

The correction angle obtaining step is a step for letting the control unit start to execute the correction angle obtaining processing by performing the correction angle obtainment starting operation.

The correction angle storing step is a step for storing the correction angle obtained as a result of the correction angle obtaining processing into a readable and writable storage device.

According to the apparatus of the present disclosure, the control unit obtains the first vehicle relative position data on the basis of the first position data obtained by the first sensor device and the correction angle which have already obtained, and utilizes that obtained first vehicle relative position data for assisting driving of the vehicle.

Namely, the operator does not have to place the reference object (namely, the target for axis direction adjustment) at a position on a vehicle longitudinal axis which extends in the longitudinal direction of the vehicle accurately such that the first vehicle relative position data can be obtained. Therefore, according to the apparatus of the present disclosure, a position of an object with respect to the vehicle can be obtained accurately even though the operator has not performed the bothersome adjustment operation that requires to place the reference object at the position on the vehicle longitudinal axis.

In another aspect of the apparatus of the present disclosure, the second sensor device is configured to obtain “second position data” including a combination of a distance (a camera object distance Dc) between the second detecting section and the second object and an angle (a radar object angle) formed between a straight line connecting the second detecting section and the second object and the vehicle reference axis. In addition, the second sensor device is configured to obtain the second vehicle relative position data on the basis of the second position data and a position (a longitudinal base point difference Ax and a lateral base point difference Δy) of the second installation position with respect to the vehicle.

Furthermore, in this aspect, the first sensor device may be a radar apparatus (30) comprising a radar transmission section (31), a radar reception section (32), and a radar control section (33). The radar transmission section is a part of the first detecting section and is configured to transmit an electromagnetic wave to the first detection region. The radar reception section is a part of the first detecting section and is configured to receive an electromagnetic wave. The radar control section is configured to obtain the first position data on the basis of the transmitted electromagnetic wave and the received electromagnetic wave. The first detecting section is disposed at a center of a front end of the vehicle in a lateral direction.

The second sensor device in this aspect may be a camera apparatus (40) comprising an image obtaining section (41), and image processing section (42). The image obtaining section is placed, as the second detecting section, at the second installation position, and is configured to obtain image data by capturing an image containing an object present in the second detection region. The second installation position is a predetermined position on a cabin side of a front windshield of the vehicle. The image processing section is configured to obtain, as image position data, on the basis of the image data (a front image), a combination of a distance between the second detecting section and the second object and an angle formed between a straight line connecting the second detecting section and the second object and a second sensor reference axis (a camera central axis Cc) extending from the second detecting section to a second predetermined direction with respect to the image processing section, and to treat (regards) the image position data as the second position data when the image obtaining section has been fixed to the vehicle such that the second sensor reference axis is parallel to a “vehicle longitudinal axis” extending in a longitudinal direction of the vehicle. The vehicle longitudinal axis serves as the vehicle reference axis.

In other words, a method of the apparatus of the present disclosure in this aspect comprises a second target placing step, and a second sensor reference axis adjustment step. These steps are carried out before the first target placing step, the correction angle obtaining step, and the correction angle storing step, described above, are carried out.

The second target placing step is a step for placing a second target at a center of a front end of the vehicle in the lateral direction. The second target is used for adjusting an axis direction of the second sensor reference axis.

The second sensor reference axis adjustment step is a step for letting the second sensor device obtain the second position data for the second target and adjusting a direction of the second detecting section such that the position of the second target indicated by the second position data coincides with a predetermined position, to thereby let the second sensor reference axis parallel to the vehicle longitudinal axis.

The operator has to place the reference object at a position on the vehicle longitudinal axis accurately in order to perform an operation (camera axis adjustment operation) of fixing the camera apparatus (more specifically, image obtaining section) to the vehicle such that the second sensor reference axis is parallel to the vehicle longitudinal axis. However, since the second sensor device of this aspect is disposed in the cabin of the vehicle, for example, the reference object used for the camera axis adjustment operation may be placed such that the reference object contacts the center part of the front end of the vehicle in the lateral direction. Therefore, according to this aspect, the operator can perform the camera axis adjustment operation without performing an adjustment operation which is bothersome.

Notably, in the above description, in order to facilitate understanding of the present disclosure, the constituent elements of the disclosure corresponding to those of an embodiment of the disclosure which will be described later are accompanied by parenthesized names and/or symbols which are used in the embodiment; however, the constituent elements of the disclosure are not limited to those in the embodiment defined by the names and/or the symbols. Other objects, other features, and attendant advantages of the present disclosure will be readily appreciated from the following description of the embodiment of the disclosure which is made with reference to the accompanying drawings.

### BRIEF DESCRIPTION OF THE DRAWINGS

FIG. 1 is a schematic diagram of a vehicle on which a driving assistance apparatus according to an embodiment of the present disclosure (present assistance apparatus) is mounted;

FIG. 2 is a block diagram of the present assistance apparatus;

FIG. 3A is a diagram illustrating a camera target used for a camera axis adjustment operation;

FIG. 3B is a diagram showing the camera target which has been placed;

FIG. 4 is a diagram illustrating a combined target used for a correction angle obtaining operation;

FIG. 5 is a diagram showing a positional relationship among a camera apparatus, a radar apparatus, and the combined target;

FIG. 6 is a flowchart representing a routine executed by an ECU shown in FIG. 2.

### DETAILED DESCRIPTION

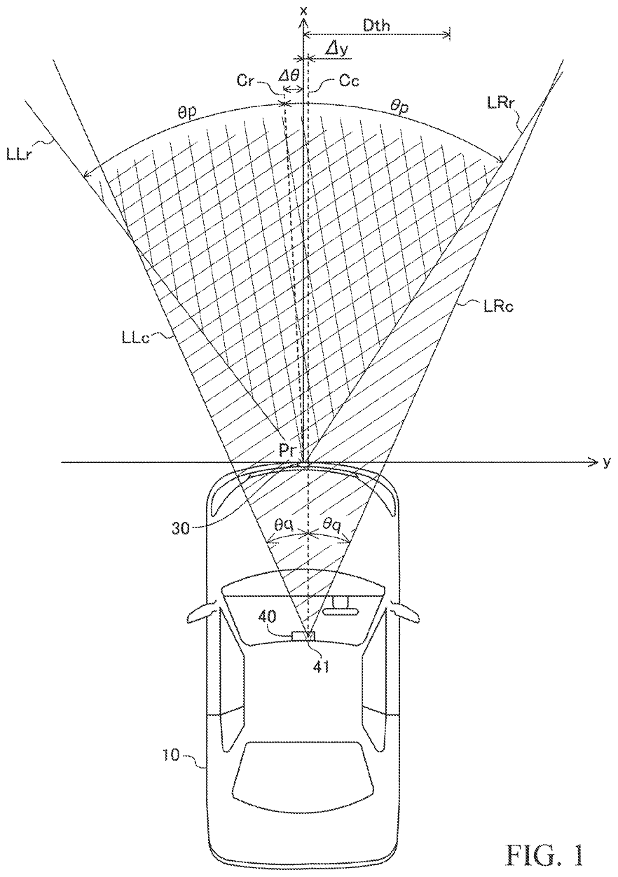

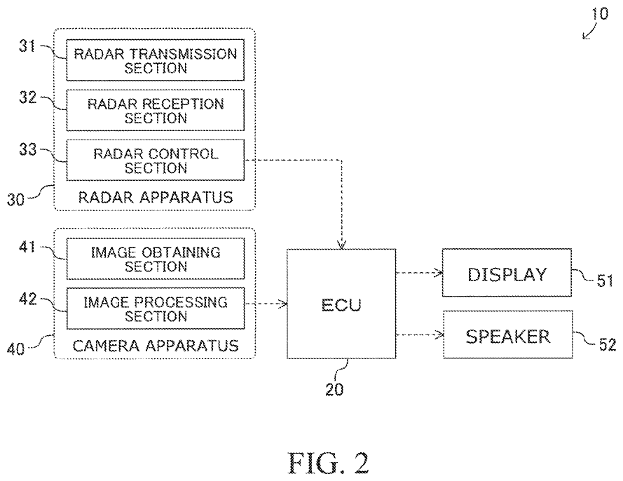

A driving assistance apparatus according to an embodiment of the present disclosure (hereinafter also referred to as the “present assistance apparatus”) will now be described with reference to the drawings. The present control apparatus is applied to a vehicle 10 shown in FIG. 1. As understood from FIG. 2 illustrating a block diagram of the present assistance apparatus, the present assistance apparatus includes an ECU 20 which is an electronic control unit (ECU).

The ECU 20 includes a micro-computer, as a major component, which is equipped with a CPU, a ROM, a RAM and a non-volatile memory. The CPU performs data reading, numerical computation, computation result output, and so on, by repeatedly executing predetermined programs (routines). The ROM stores the programs executed by the CPU, lookup tables (maps) read by the CPU during execution of the programs, and so on. The RAM stores data read by the CPU temporarily. The non-volatile memory formed by a rewritable flash memory and stores data peculiar to the vehicle 10 itself such as a correction angle Δθ, which is described later.

The ECU 20 is connected to a radar apparatus 30, a camera apparatus 40, a display 51 and a speaker 52. The radar apparatus 30 is also referred to as a “first sensor device” for convenience'sake. The camera apparatus 40 is also referred to as a “second sensor device” for convenience'sake.

### (Configuration—Radar Apparatus)

The radar apparatus 30 is a millimeter-wave radar apparatus, and disposed at the center of the front end of the vehicle 10 (at the center position in the lateral direction) as shown in FIG. 1. This position at which the radar apparatus 30 is disposed is also referred to as a “first installation/disposed position” for convenience'sake.

The radar apparatus 30 can detect an object(s) that is (are) present in a region referred to as a radar detection region. The radar detection region is approximately equal to a range/area between a straight line LRr and a straight line LLr in the horizontal plane and within a predetermined distance from the radar apparatus 30. The center angle of the radar detection region is equal to the angle formed between the straight line LRr and the straight line LLr. The radar detection region is also referred to as a “first detection region” for convenience' sake.

A radar central axis Cr is on a straight line (half line) which extends from the radar apparatus 30 (more specifically, from a radar base point Pr described later) to the front direction (referred to as the first predetermined direction) of the radar apparatus 30. The radar central axis Cr is also referred to as a “first sensor reference axis” for convenience'sake. An angle formed between the radar central axis Cr and the straight line LRr is an angle θp and an angle formed between the radar central axis Cr and the straight line LLr is also the angle θp. Therefore, the radar central axis Cr is on a bisector of the angle formed between the straight line LRr and the straight line LLr.

The radar apparatus 30 obtains (measures) location data (also referred to as a “first position data” for convenience'sake) that identifies a position of an object with respect to the radar apparatus 30 and velocity data that represents velocity (or moving velocity) of the object.

The first position data includes a combination (pair) of a radar object distance Dr and a radar object angel θr described as (Dr, θr) hereinafter. The radar object distance Dr is a distance between the radar apparatus 30 (more specifically, the radar base point Pr) and an object. The radar object angel θr is an angle formed between a “straight line (line segment) from the radar base point Pr to the object” and the radar central axis Cr.

When an object is on the radar central axis Cr, the radar object angel θr is “0.” When an object is in a region between the radar central axis Cr and the straight line LRr, the radar object angel θr is a positive value (namely, θr>0), and the magnitude of the radar object angel θr becomes larger as the object comes closer to the straight line LRr. When an object is in a region between the radar central axis Cr and the straight line LLr, the radar object angel θr is a negative value (namely, θr<0), and the magnitude of the radar object angel θr becomes larger as the object comes closer to the straight line LLr. Therefore, the radar object angel θr falls within the range of (−1)×θp to θp.

A position where the radar object distance Dr is “0” is also referred to as the radar base point Pr. As shown in FIG. 1, in the present embodiment, an x-y coordinate system having the origin at the radar base point Pr is used/introduced. An axis (vehicle longitudinal axis) which extends in the longitudinal direction of the vehicle 10 is defined as an x axis, and an axis which extends in the lateral direction (width direction) of the vehicle 10 is defined as a y axis. Thus, the x axis and the y axis are orthogonal to each other. The x coordinate assumes a positive value on one side of the origin toward the forward direction of the vehicle 10 and assumes a negative value on the other side of the origin toward the backward direction of the vehicle 10. The y coordinate assumes a positive value on the right side with respect to the heading direction of the vehicle 10 moving forward and assumes a negative value on the left side with respect to the heading direction of the vehicle 10 moving forward. The x axis (namely, vehicle longitudinal axis) is also referred to as a “vehicle reference axis” for convenience' sake

An angle formed between the x axis (namely, the longitudinal direction of the vehicle 10) and the radar central axis Cr is referred to as a correction angle Δθ. A method to obtain the correction angle Δθ is described later. When the radar central axis Cr is in a region where x>0 and y>0 (namely, when the radar central axis Cr extends in a diagonally right direction of the vehicle 10), the correction angle Δθ is a positive value (namely, Δθ>0). When the radar central axis Cr is in a region where x>0 and y<0 (namely, the radar central axis Cr extends in a diagonally left direction of the vehicle 10), the correction angle Δθ is a negative value (namely, Δθ<0). In the case shown in FIG. 1 as an example, the radar central axis Cr extends in the diagonally left direction of the vehicle 10 from the radar base point Pr. Thus, the correction angle Δθ shown in FIG. 1 is a negative value.

The velocity data obtained by the radar apparatus 30 contains a combination (pair) of an object distance velocity Vd and an object angular velocity Va. The object distance velocity Vd indicates the change amount of/in the radar object distance Dr per unit time. The object angular velocity Va indicates the change amount of/in the radar object angel θr per unit time.

As shown in FIG. 2, the radar apparatus 30 includes a radar transmission section 31, a radar reception section 32, and a radar control section 33. The radar transmission section 31 transmits a millimeter wave (namely, electromagnetic wave whose frequency falls within the range of 30 GHz to 300 GHz) as a “radar transmission wave” in response to an instruction from the radar control section 33. The radar reception section 32 includes a plurality of reception antennas (not shown). The radar reception section 32 receives, through the reception antennas, a reflection wave (i.e., radar reflection wave) which is generated by a reflection of the radar transmission wave at an object. The radar reception section 32 outputs information on the radar reflection wave received through the reception antennas to the radar control section 33.

The radar transmission section 31 and the radar reception section 32 are also referred to as “first detecting section” collectively. Therefore, the radar base point Pr coincides with the position of the first detecting section. Notably, the radar transmission section 31, the radar reception section 32 and the radar control section 33 according to the present embodiment are housed in a housing (case), however, the first detecting section which includes the radar transmission section 31 and the radar reception section 32, and the radar control section 33 may be housed in deferent housings (cases) respectively to be separated from each other.

When the vehicle 10 is in a “drivable state,” the radar control section 33 executes “radar object detecting processing” every time a predetermined time interval ΔTr (fixed value) elapses. The vehicle 10 is in the drivable state in a period from a point in time when an ON operation to an unillustrated ignition switch of the vehicle 10 is performed to a point in time when an OFF operation to the ignition switch is performed, except for a “camera axis adjustment period” described later and a “correction angle obtainment period” described later.

The radar object detecting processing is processing to obtain (measure) and/or figure out the first position data and the velocity data of an object (also referred to as a “first object” for convenience'sake) that is present in the first detection region on the basis of “strength, the frequency and the phase of the radar reflected wave,” “the time difference from the transition of the radar transmission wave to the reception of the radar reflection wave,” and the like.

The radar control section 33 assigns an identifier to an object (hereinafter, also referred to as a “radar detected object”) of which the first position data has been obtained. When a plurality of the radar detected objects are present, the radar control section 33 assigns different (unique) identifiers to them.

After executing the radar object detecting processing, the radar control section 33 transmits “radar object information” to the ECU 20. When the radar detected object is present, the radar object information includes the identifier, the first position data (Dr, θr) and the velocity data of the radar detected object. A position represented (indicated) by first position data (Dr, θr) is also referred to as a “radar detected position.”

### (Configuration—Camera Apparatus)

The camera apparatus 40 is disposed at a position on the cabin side of a front windshield of the vehicle 10 near an unillustrated inner rear-view mirror (a room mirror) fixed at a center upper portion of the front windshield. More specifically, the center in the lateral direction of the housing of the camera apparatus 40 is positioned at the center of the vehicle 10 in the lateral direction (namely, on the x coordinate). As shown in FIG. 2, the camera apparatus 40 includes an image obtaining/capturing section 41 and an image processing section 42.

The image obtaining section 41 is disposed (positioned) in the housing of the camera apparatus 40 and at a position displaced by a short length (specifically, lateral base point difference Ay described later) to the right side of the vehicle 10 from the center of the camera apparatus 40 in the lateral direction. The position at which the image obtaining section 41 is disposed with respect to the vehicle 10 is also referred to as a “second installation position” for convenience'sake. The image obtaining section 41 is also referred to as a “second detecting section” for convenience'sake.

The image obtaining section 41 obtains (captures) an image data (more specifically, static image data) representing a “front image” every time a predetermined time interval ΔTc (fixed value) elapses, and outputs the front image to the image processing section 42. The front image contain(s) an object(s) in front of the vehicle 10 and a landscape. A detection region of the image obtaining section 41 (namely, camera detecting region) in the lateral plane is equal to a range between a straight line LRc and a straight line LLc shown in FIG. 1. Thus, the angle of view (field of view) of the image obtaining section 41 in the lateral plane is represented by an angle formed between the straight line LRc and the straight line LLc. The camera detecting region is also referred to as a “second detecting region” for convenience'sake.

A camera central axis Cc shown in FIG. 1 is on a straight line (half line) which extends from the camera apparatus 40 (more specifically, a camera base point Pc described later) to the front direction of the camera apparatus 40. The camera central axis Cc is also referred to as a “second sensor reference axis” for convenience'sake. The extending direction represented by the camera central axis Cc from the camera base point Pc is also referred to as a “second predetermined direction” for convenience'sake. An angle formed between the camera central axis Cc and the straight line LRc is an angle θq and an angle formed between the camera central axis Cc and the straight line LLc is also the angle θq. Therefore, the camera central axis Cc is on a bisector of the angle formed between the straight line LRc and the straight line LLc. As a result of a camera axis adjustment operation described later, the camera central axis Cc is parallel to the x coordinate. In other words, the camera central axis Cc is parallel to the vehicle longitudinal axis (namely, the vehicle reference axis).

When the vehicle 10 is in the drivable state, the image processing section 42 executes “camera object detecting processing” every time the image processing section 42 receives image data from the image obtaining section 41 (namely, every time the time interval ΔTc elapses). The camera object detecting processing is processing to detect (extract) an object contained in the image data (specifically, the front image represented by the image data) by means of a well-known method (in the present embodiment, a template matching method) and to obtain position data representing (indicating) a position of the detected object with respect to the camera apparatus 40. This obtained position data is also referred to as “image position data” and “second position data” for convenience'sake. Namely, the camera object detecting processing is processing to obtain (measure) and/or figure out the second position data of an object (also referred to as “second object” and “camera detected object”) which is present in the second detecting region.

The second position data includes a combination (pair) of a camera object distance Dc and a camera object angle θc, described as (Dc, θc) hereinafter. The camera object distance Dc is a distance between the camera apparatus 40 (more specifically, the camera base point Pc) and an object (namely, the camera detected object). The camera object angle θc is an angle formed between a “straight line (line segment) from the camera base point Pc to the camera detected object” and the camera central axis Cc.

When an object is on the camera central axis Cc, the camera object angle θc is “0.” When an object is in a region between the camera central axis Cc and the straight line LRc, the camera object angle θc is a positive value (namely, θc>0), and the magnitude of the camera object angle θc becomes larger as the object comes closer to the straight line LRc. When an object is in a region between the camera central axis Cc and the straight line LLc, the camera object angle θc is a negative value (namely, θc<0), and the magnitude of the camera object angle θc becomes larger as the object comes closer to the straight line LLc. Therefore, the camera object angle θc falls within the range of (−1)×θq to θq.

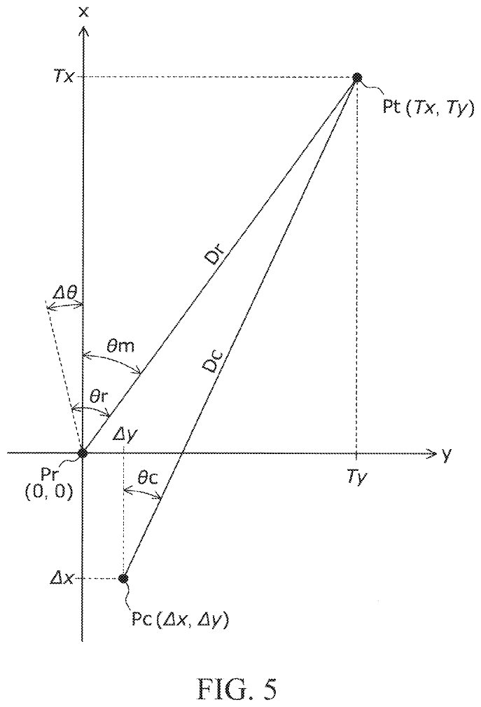

A position where the camera object distance Dc is “0” is also referred to as the camera base point Pc shown in FIG. 5 which is explained later. An x coordinate value of the camera base point Pc is also referred to as a longitudinal base point difference Δx. Namely, a distance in the x coordinate direction between the radar base point Pr and the camera base point Pc is equal to the magnitude |Δx| of the longitudinal base point difference Δx. A y coordinate value of the camera base point Pc is also referred to as a lateral base point difference Δy. In the present embodiment, since the radar apparatus 30 is disposed at the first installation position (specifically, the radar base point Pr) and the image obtaining section 41 of the camera apparatus 40 is disposed at the second installation position (specifically, the camera base point Pc), the longitudinal base point difference Δx is a negative value (namely, Δx<0) and the lateral base point difference Δy is a positive value (namely, Δy>0).

The image processing section 42 assigns an identifier to the camera detected object of which the second position data has been obtained. When a plurality of the camera detected objects are present, the image processing section 42 assigns different (unique) identifiers to them. In addition, if the camera detected object which has been detected by the camera object detecting processing executed last time is detected this/current time again (namely, if the camera detected object is detected both at a time point the time interval ΔTc before and at the present time), the image processing section 42 assigns the same identifier as that assigned to the object when the camera object detecting processing is executed last time (so that the identifier remains unchanged).

After executing the camera object detecting processing, the image processing section 42 transmits “camera object information” to the ECU 20. When the camera detected object is present, the camera object information includes the identifier and the second position data (Dc, θc). A position represented by the second position data (Dc, θc) is also referred to as a “camera detected position.”

### (Configuration—Others)

The display 51 shown in FIG. 2 is an LCD (liquid crystal display) mounted at a position which is easily viewable for a driver of the vehicle 10 (namely, in front of the driver). Characters, figures, and the like displayed on the display 51 are controlled by the ECU 20. In addition, the display 51 also functions as a touch panel. Accordingly, the driver can send instructions to the ECU 20 by touching the display 51.

The speaker 52 is disposed inside a vehicle compartment of the vehicle 10. A warning sound, a voice message and the like played by the speaker 52 are controlled by the ECU 20.

### (Collision Alert Processing)

When the vehicle 10 is in the drivable state, the ECU 20 determines whether or not an object which is highly likely to collide with the vehicle 10 is present by means of a method described later. In addition, when the ECU 20 determines that such an object is present, the ECU 20 generates an alert to the driver using the display 51 and the speaker 52. Specifically, the ECU 20 displays, on the display 51, characters and figures showing that the vehicle 10 is highly likely to collide with the object, and causes the speaker 52 to reproduce a warning sound.

An object which is to be subjected to the alert (namely, an object which is determined to be highly likely to collide with the vehicle 10, and thus, for which the alert should be generated) is also referred to as an “alert target object.” This series of processes is also referred as “collision alert processing.” The collision alert processing is also referred to as a “driving assistance processing” for convenience'sake, since it is executed in order to assist the driver of the vehicle 10 to drive.

When an object which satisfies both a condition (1) and a condition (2) described below is present, the ECU 20 determines that the object is the alert target object.

Condition (1): the magnitude IDA of the lateral distance Dy (namely, an absolute value of the y coordinate value of the object in the x-y coordinate system) of the object is less than a predetermined distance threshold Dth shown in FIG. 1 (namely, |Dy|<Dth).

Condition (2): a collision time (or time to collision) TTC that is an estimated time length from a current time point to a time point at which the vehicle 10 will collide with the object is less than a predetermined time threshold Tth.

In order to determine whether or not the radar detected object is the alert target object, the ECU 20 figures out a longitudinal distance Dx (namely, the x coordinate value) and the lateral distance Dy on the basis of the first data (namely, the radar object distance Dr and the radar object angle θr) of the radar detected object in accordance with the following expression (1) and expression (2). Notably, data of a radar detected object including the longitudinal distance Dx and the lateral distance Dy is data which represents (indicates) the position of the radar detected object (first object) with respect to the vehicle 10 and is also referred to as “first vehicle relative position data” for convenience'sake.

Dx=Dr×cos(θr+Δθ) (1)

Dy=Dr×sin(θr+Δθ) (2)

When the radar detected object whose magnitude of the lateral distance Dy figured out in accordance with the expression (2) is less than the distance threshold Dth is present (namely, the condition (1) is satisfied), the ECU 20 figures out the collision time TTC of that object. Specifically, the ECU 20 figures out the collision time TTC on the basis of the quotient of division of the longitudinal distance Dx by a longitudinal relative velocity Vx of the object (namely, TTC=Dx/Vx). Further, the ECU 20 determines whether or not the condition (2) is satisfied on the basis of the collision time TTC. Notably, the longitudinal relative velocity Vx indicates the change amount of the longitudinal distance Dx per unit time, and the ECU 20 figures out the longitudinal relative velocity Vx on the basis of the velocity data (namely, the object distance velocity Vd and the object angular velocity Va) by means of a well-known method.

In addition, in order to determine whether or not the camera detected object is an alert target object, the ECU 20 figures out the longitudinal distance Dx and the lateral distance Dy on the basis of the second data (namely, the camera object distance Dc and the camera object angle θc) of the camera detected object in accordance with the following expression (3) and expression (4). Notably, data of the camera detected object including the longitudinal distance Dx and the lateral distance Dy is data which represents (indicates) the position of the camera detected object (second object) with respect to the vehicle 10 and is also referred as “second vehicle relative position data” for convenience'sake.

Dx=Dc×cos(θc)+θx (3)

Dy=Dc×sin(θc)+θy (4)

When the camera detected object whose magnitude of the lateral distance Dy figured out in accordance with the expression (4) is less than the distance threshold Dth is present (namely, the condition (1) is satisfied), the ECU 20 determines whether or not the condition (2) is satisfied on the basis of the collision time TTC of that object. Specifically, in order to figure out the collision time TTC, the ECU 20 figures out the longitudinal relative velocity Vx by dividing the difference between the longitudinal distance Dx and a previous longitudinal distance Dxp, which is described later, by the time interval ΔTc (namely, Vx=(Dx−Dxp)/ΔTc). In addition, the ECU 20 figures out the collision time TTC on the basis of the quotient of division of the longitudinal distance Dx by the longitudinal relative velocity Vx of the object (namely, TTC=Dx/Vx).

It should be noted that the longitudinal distance Dx is a value figured out on the basis of the second position data contained in the latest camera object information (latest object information) received from the camera apparatus 40. Meanwhile, the previous longitudinal distance Dxp is a value figured out on the basis of the second position data contained in camera object information received from the camera apparatus 40 just before the latest object information (namely, camera object information received at a point in time before a point in time when the ECU 20 received the latest object information by the time interval ΔTc).

### (Camera Axis Adjustment Operation)

When the camera apparatus 40 is installed/disposed to the vehicle 10, “the camera axis adjustment operation/work” is performed for adjusting the axial direction of the camera central axis Cc (namely, the second sensor reference axis). The camera axis adjustment operation is an operation to adjust the mounting angle of the camera apparatus 40 in the horizontal direction/plane with respect to the vehicle 10 such that the direction of the camera central axis Cc and the longitudinal direction of the vehicle 10 are parallel to each other (namely, the second sensor reference axis is parallel to the vehicle reference axis (the vehicle longitudinal axis)). More specifically, the camera axis adjustment operation is performed to adjust the angle of the camera apparatus 40 so as to make the lateral distance Dy obtained on the basis of the camera object information coincide with the actual/true value of the lateral distance Dy.

For example, after repair or replacement of the camera apparatus 40, the camera axis adjustment operation is performed. Of course, the camera axis adjustment operation is performed when the vehicle 10 is manufactured (the camera apparatus 40 is installed) in a factory.

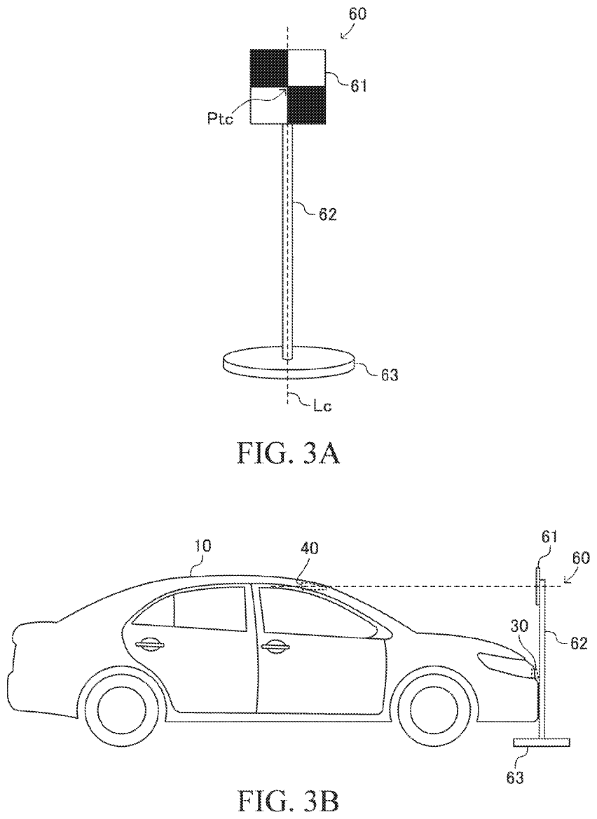

When the camera axis adjustment operation is performed, a camera target 60 shown in FIG. 3A is utilized. The camera target 60 includes a target section 61, a pillar section 62 and a base section 63. The target section 61 is a flat board having a square shape. The surface of the target section 61 is painted (applied) with a color pattern that allows the camera apparatus 40 to obtain the position of the target section 61 (namely, the camera detected position) accurately. The center in horizontal and vertical directions of the surface of the target section 61 is also referred to as an optical target benchmark/reference point Ptc.

The back side of the target section 61 is fixed to the pillar section 62 such that a lateral center line of the target section 61 (namely, a line extending in the vertical direction through the center in the horizontal direction of the target section 61) coincides with a lateral center line of the pillar section 62. A broken line Lc in FIG. 3A indicates these lateral center lines.

The pillar section 62 is supported by and stands on the base section 63 such that the pillar section 62 extends from the center of the base section 63 in the vertical direction. The base section 63 is a disk-shaped base. Therefore, when the camera target 60 is placed on a horizontal place/plane, the axis line of the pillar section 62 extends in the vertical direction. The camera target 60 has been previously formed/made such that the height of the optical target benchmark point Ptc coincides with the height of the camera apparatus 40 installed in (fixed to) the vehicle 10.

As shown in FIG. 3B, an operator of the camera axis adjustment operation places (arranges) the camera target 60 such that the pillar section 62 contacts with the center of the front end of the vehicle 10 (the center position in the lateral direction at the front end of the vehicle 10) and the surface of the target section 61 shown in FIG. 3A faces the camera apparatus 40 (namely, the surface of the target section 61 is parallel to the lateral direction of the vehicle 10 in planar view).

Consequently, the position of the optical target benchmark point Ptc on the target section 61 with respect to the vehicle 10 coincides with the radar base point Pr (namely, the origin of the x-y coordinate). Namely, at this time, the actual value of the lateral distance Dy of the optical target benchmark point Ptc is “0.” This step for placing (positioning) the camera target 60 at the center in the lateral direction of the front end of the vehicle 10 is also referred to as a “second target placing” for convenience'sake.

When the operator performs a predetermined “camera axis adjustment starting operation (manipulation)” to the display 51 (namely, the touch panel) so that a signal indicating that the camera axis adjustment starting operation has been performed is input to the ECU 20, the ECU 20 starts “camera axis adjustment processing.” The camera axis adjustment processing is processing to repeat obtaining (figuring out) the “lateral distance Dy of the optical target benchmark point Ptc on the target section 61 contained in the front image” in accordance with the expression (4) and displaying that obtained lateral distance Dy on the display 51 at a prescribed time interval.

When the camera axis adjustment processing is executed, the ECU 20 searches for a “partial region (similar region) in the front image” that is similar to a stored template corresponding to the color pattern on the surface of the target section 61. When the ECU 20 succeeds to find the similar region, the ECU 20 obtains the lateral distance Dy of the center in the lateral direction of the similar region (namely, the lateral distance Dy of the optical target benchmark point Ptc) and displays that lateral distance Dy on the display 51. Meanwhile, if the ECU 20 fails to find the similar region, the ECU 20 displays, on the display 51, characters and figures showing that the target section 61 is not contained in the front image.

The operator adjusts the mounting angle of the camera apparatus 40 such that the lateral distance Dy displayed on the display 51 becomes “0.” As described above, the camera apparatus 40 (specifically, the image obtaining section 41) is installed/arranged such that the camera base point Pc is displaced to the right side by the lateral base point difference Ay from the center in the lateral direction of the vehicle 10. Therefore, if the camera central axis Cc and the longitudinal direction of the vehicle 10 (namely, the vehicle longitudinal axis) are parallel to each other, the first term of the right side in the expression (4) (=Dc×sin(θc)) becomes equal to “−Δy,” since the camera object angle θc of the optical target benchmark point Ptc is obtained accurately. In other words, when the camera central axis Cc and the vehicle longitudinal axis are parallel to each other, the lateral distance Dy of the optical target benchmark point Ptc figured out in accordance with the expression (4) becomes equal to “0.”

In view of the above, when the lateral distance Dy displayed on the display 51 becomes “0,” the operator fixes the mounting angle of the camera apparatus 40 firmly. This step in which the operator makes (lets) the ECU 20 start executing the camera axis adjustment processing and fixes (adjusts) the mounting angle of the camera apparatus 40 such that the lateral distance Dy displayed on the display 51 becomes “0” is also referred to as a “second sensor reference axis adjustment step” for convenience'sake.

After that, the operator performs a predetermined “camera axis adjustment stopping operation (manipulation)” using the display 51 to input, to the ECU 20, a signal indicating that the camera axis adjustment stopping operation has been performed. Consequently, the ECU 20 stops executing the camera axis adjustment processing. Thus, the camera axis adjustment operation is finished. A period in which the ECU 20 executes camera axis adjustment processing (namely, a period from a point in time when the camera axis adjustment starting operation is performed to a point in time when the camera axis adjustment stopping operation is performed) is also referred to as the “camera axis adjustment period.”

### (Correction Angle Obtaining Operation of Radar Apparatus)

Meanwhile, when the radar apparatus 30 is installed/attached to the vehicle 10, “a correction angle obtaining operation” is performed for causing the ECU 20 to obtain the correction angle Δθ described above (see the expression (1) and the expression (2)). For example, after repair or replacement of the radar apparatus 30, the correction angle obtaining operation is performed. The correction angle obtaining operation is also performed when the vehicle 10 is manufactured (the radar apparatus 30 is installed) in a factory.

The correction angle obtaining operation is performed in a state where the camera central axis Cc and the vehicle longitudinal axis (namely, the x axis) are parallel to each other (namely, in a state where the camera axis adjustment operation has already been performed). Therefore, for example, when both the camera apparatus 40 and the radar apparatus 30 are replaced, the camera axis adjustment operation is performed at first, and then, the correction angle obtaining operation is performed.

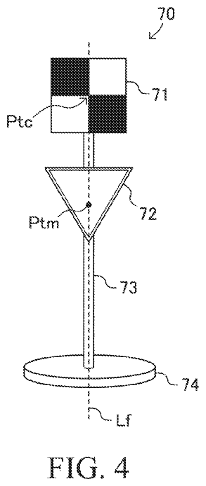

When the correction angle obtaining operation is performed, a combined target 70 shown in FIG. 4 is utilized. The combined target 70 includes an optical target 71, a millimetric-wave target 72, a pillar section 73 and a base section 74. In the present embodiment, the optical target 71 is same as the target section 61. Therefore, the center in horizontal and vertical directions of the surface of the optical target 71 is also referred to as the optical target benchmark point Ptc. The combined target 70 is also referred to as a “first target” for convenience'sake.

The center in horizontal and vertical directions of the surface of the millimetric-wave target 72 is also referred to as a millimetric-wave target benchmark point Ptm. In order for the radar apparatus 30 to obtain the position of the millimetric-wave target 72 accurately, material and shape having high reflectance to the radar transmission wave are employed for the surface of the millimetric-wave target 72. Therefore, when the radar apparatus 30 detects the millimetric-wave target 72 as the radar detected object, the position of the millimetric-wave target benchmark point Ptm with respect to the radar apparatus 30 is obtained as the radar detected position.

The back side of the optical target 71 and the back side of the millimetric-wave target 72 are fixed to the pillar section 73 respectively such that each of lateral center lines of the optical target 71 and the millimetric-wave target 72 in the vertical direction coincides with a lateral center line of the pillar section 73 (namely, the lateral center line of the pillar section 73 which extends in the vertical direction through the centers in the horizontal direction of the optical target 71 and the millimetric-wave target 72). A broken line Lf in FIG. 4 indicates these lateral center lines.

The pillar section 73 is supported by and stands on the base section 74 such that the pillar section 73 extends from the center of the base section 74 in the vertical direction. The base section 74 is a disk-shaped base. Therefore, when the combined target 70 is placed on a horizontal place/plane, the axis line of the pillar section 73 extends in the vertical direction. The combined target 70 has been previously made such that the height of the optical target benchmark point Ptc of the optical target 71 coincides with the height of the camera apparatus 40 installed in (fixed to) the vehicle 10 and the height of the millimetric-wave target benchmark point Ptm coincides with the height of the radar apparatus 30 installed in (fixed to) the the vehicle 10.

Therefore, if the camera axis adjustment operation has already been finished and the correction angle Δθ has already been obtained accurately, a combination (pair) of the longitudinal distance Dx and the lateral distance Dy of the millimetric-wave target benchmark point Ptm on the millimetric-wave target 72 obtained on the basis of the radar object information coincides with (is the same as) a combination (pair) of the longitudinal distance Dx and the lateral distance Dy of the optical target benchmark point Ptc on the optical target 71 obtained on the basis of the camera object information.

The operator of the correction angle obtaining operation places/positions the combined target 70 at a position which is included in (which is within) both the camera detecting region and the radar detecting region. A region where the camera detecting region and the radar detecting region overlap each other is also referred to as an “overlapped detecting region” for convenience'sake. The position at which the combined target 70 is located/positioned is also referred to as a “reference position” for convenience'sake. The reference position is an arbitrary position in the overlapped detecting region. In placing the combined target 70 at the reference position, the operator places (arranges) the combined target 70 such that the surface of the millimetric-wave target 72 and the surface of the optical target 71 are approximately parallel to the lateral direction of the vehicle 10. This step in which the operator places the combined target 70 at the reference position is also referred to as a “first target placing step” for convenience' sake.

FIG. 5 is an example of the x-y coordinate system in a case where the combined target 70 is placed/positioned during the correction angle obtaining operation. In the example of FIG. 5, the placed position of the combined target 70 is a point Pt (Tx, Ty). Namely, the point Pt indicates the optical target benchmark point Ptc of the optical target 71 obtained on the basis of the camera object information. In addition, the point Pt also indicates the millimetric-wave target benchmark point Ptm of the millimetric-wave target 72 obtained on the basis of the radar object information. In FIG. 5, an actual angle θm is an angle formed between a line segment from the radar base point Pr of the radar apparatus 30 to the point Pt which is the position of the combined target 70 (namely, the position of the millimetric-wave target benchmark point Ptm) and the x axis. The actual angle θm increases in the clockwise direction (right-hand turning) with respect to the x axis. Notably, in the example of FIG. 5, the correction angle Δθ is a negative value (namely, Δθ<0).

Thus, the radar object angel θr of the combined target 70 (the millimetric-wave target benchmark point Ptm) obtained by the radar apparatus 30 is equal to the difference between the actual angle θm and the correction angle Δθ (namely, θr=θm−Δθ). Therefore, the relationship represented by the following expression (5) is satisfied.

Δθ=θm−θr (5)

Meanwhile, as understood from FIG. 5, the relationships represented by the following expression (6) and the following expression (7) are satisfied.

Tx=Dr×cos(θm)=Dc×cos(θc)+Δx (6)

Ty=Dr×sin(θm)=Dc×sin(θc)+Δy (7)

Further, the relationship represented by the following expression (8) is obtained by eliminating the camera object distance Dc from the expression (6) and the expression (7). Therefore, the relationship represented by the following expression (9) obtained based on the expression (8) is satisfied.

Dr×sin(θm−θc)=Δx×sin(θc)−Δy×cos(θc) (8)

θm=arcsin({Δx×sin(θc)−θy×cos(θc)}/Dr)+θc (9)

The correction angle obtaining operation is performed on the basis of the relationships between parameters described above. Specifically, the operator performs a predetermined “correction angle obtainment starting operation (manipulation)” to the display 51 after placing the combined target 70 at a position in the overlapped detecting region (namely, the reference position).

Accordingly, a signal indicating that the correction angle obtainment starting operation has been performed is input to the ECU 20, and then, the ECU 20 executes “correction angle obtaining processing.” The correction angle obtaining processing includes following processes (a) to (e). The step in which the operator performs the correction angle obtainment starting operation so as to cause the ECU 20 to start executing the correction angle obtaining processing is also referred to as a “correction angle obtaining step” for convenience' sake.

(a) the ECU 20 receives the camera detected position (Dc, θc) of the optical target benchmark point Ptc of the combined target 70 from the camera apparatus 40.

(b) the ECU 20 receives the radar detected position (Dr, θr) of the millimetric-wave target benchmark point Ptm of the combined target 70 from the radar apparatus 30.

(c) the ECU 20 figures out the actual angle θm by assigning (applying) the obtained “θc and Dr” to the expression (9).

(d) the ECU 20 figures out the correction angle Δθ by assigning the actual angle θm which has been figured out and the radar object angel θr which has been received from the radar apparatus 30 to the expression (5).

(e) the ECU 20 stores the correction angle Δθ which has been figured out into the non-volatile memory (namely, a storage device) and displays, on the display 51, a message showing that the correction angle Δθ has been figured out.

Confirming that the message showing that the correction angle Δθ has been figured out is displayed on the display 51, the operator performs a predetermined “correction angle obtainment stopping operation (manipulation)” to the display 51. Accordingly, a signal indicating that the correction angle obtainment stopping operation has been performed is input to the ECU 20, and then, the ECU 20 stops executing the correction angle obtaining processing. The step in which the ECU 20 stores the correction angle Δθ which is figured out in/into the non-volatile memory is also referred to as a “correction angle storing step” for convenience'sake.

Thus, the correction angle obtaining operation is finished. A period from a point in time when the correction angle obtainment starting operation is performed to a point in time when the correction angle obtainment stopping operation is performed is also referred to as the “correction angle obtainment period.” The correction angle obtainment period is a period for which the ECU 20 executes a correction angle obtaining processing routine described later.

### (Specific Operation)

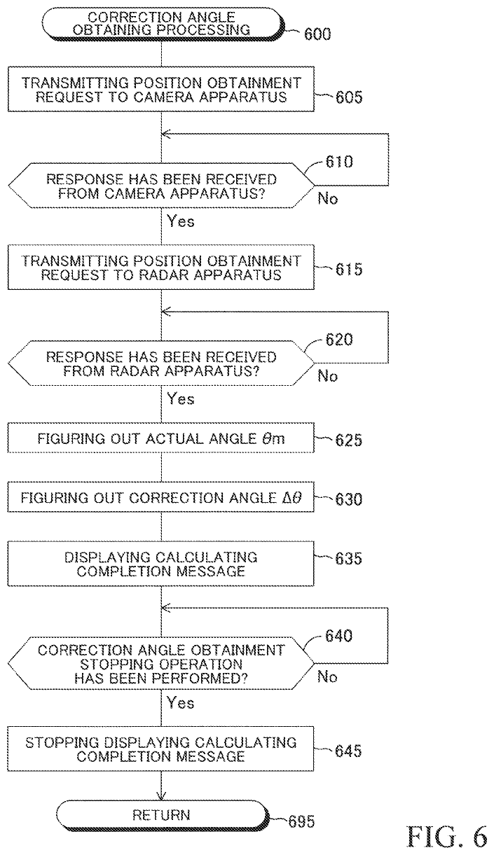

Next, specific operation of the ECU 20 in a case where the correction angle obtaining operation is performed will be described. First, the operator places the combined target 70 in the overlapped detecting region in accordance with the procedure described above. Then, when the operator performs the correction angle obtainment starting operation, the CPU of the ECU 20 (also referred to as “the CPU” for simplification) executes the “correction angle obtaining processing routine” represented by a flowchart shown in FIG. 6. Namely, the CPU starts the process from step 600. Subsequently, the CPU proceeds to step 605 so as to transmit a request (position obtainment request) to the camera apparatus 40 (specifically, the image processing section 42) in order to obtain the position of the optical target benchmark point Ptc (namely, a combination of the camera object distance Dc and the camera object angle θc) of the optical target 71.

Subsequently, the CPU proceeds to step 610 so as to determine whether or not a response (response to the position obtainment request) including the position of the optical target 71 has been received from the camera apparatus 40. If the response has not been received from the camera apparatus 40, the CPU makes a “No” determination in step 610 and executes the process of step 610 again.

Meanwhile, if the response has been received from the camera apparatus 40, the CPU makes a “Yes” determination in step 610 and proceeds to step 615 so as to transmit a request (position obtainment request) to the radar apparatus 30 (specifically, the radar control section 33) in order to obtain the position of the millimetric-wave target benchmark point Ptm (namely, a combination of the radar object distance Dr and the radar object angel θr) of the millimetric-wave target 72.

Subsequently, the CPU proceeds to step 620 so as to determine whether or not a response (response to the position obtainment request) including the position of the millimetric-wave target 72 has been received from the radar apparatus 30. If the response has not been received from the radar apparatus 30, the CPU makes a “No” determination in step 620 and executes the process of step 620 again.

Meanwhile, if the response has been received from the radar apparatus 30, the CPU makes a “Yes” determination in step 620 and proceeds to step 625. In step 625, the CPU figures out the actual angle θm in accordance with the expression (9) on the basis of “the camera object distance Dc and the camera object angle θc which indicate the position of the optical target 71” and “the radar object distance Dr and the radar object angel θr which indicate the position of the millimetric-wave target 72.”

Subsequently, the CPU proceeds to step 630 so as to figure out the correction angle Δθ in accordance with the expression (5) on the basis of the actual angle θm which has been figured out and the radar object angel θr of the millimetric-wave target 72. In addition, the CPU stores the correction angle Δθ which has been figured out in/into the non-volatile memory.

Further, the CPU proceeds to step 635 so as to display, on the display 51, the message (calculating completion message) showing that the correction angle Δθ has been figured out. Subsequently, the CPU proceeds to step 640 so as to determine whether or not the operation (manipulation) to the display 51 as the touch panel (namely, the correction angle obtainment stopping operation) has been performed. If the correction angle obtainment stopping operation has not been performed, the CPU makes a “No” determination in step 640 and executes the process of step 640 again.

Meanwhile, if the correction angle obtainment stopping operation has been performed, the CPU makes a “Yes” determination in step 640 and proceeds to step 645 so as to stop displaying the calculating completion message on the display 51. Subsequently, the CPU proceeds to step 695 so as to end the present routine.

Meanwhile, when the vehicle 10 is in the drivable state (namely, the present time is included by neither the camera axis adjustment period nor the correction angle obtainment period), the CPU executes a routine (not shown) so as to determine the alert target object is present in accordance with the expression (1) to the expression (4), the condition (1) and the condition (2). When the alert target object is present (detected), the CPU generates an alert using the display 51 and the speaker 52. Namely, the CPU executes the driving assistance processing during a period other than the correction angle obtainment period and the camera axis adjustment period.

As having been described above, in the correction angle obtaining operation to obtain the correction angle Δθ of the radar apparatus 30, the position of the combined target 70 obtained by the camera apparatus 40 whose mounting angle to the vehicle 10 has already been adjusted by the camera axis adjustment operation is utilized. After the correction angle Δθ is obtained, the ECU 20 can obtain the longitudinal distance Dx and the lateral distance Dy of the radar detected object on the basis of the radar detected position (Dr, θr) obtained by the radar apparatus 30 and the correction angle Δθ.

In addition, in the correction angle obtaining operation of the radar apparatus 30, it is not necessary to place the combined target 70 at a position on the vehicle longitudinal axis of the vehicle 10 passing through the radar base point Pr (namely, the x axis) exactly/accurately, rather the operator may simply place the combined target 70 at a position in the overlapped detecting region (namely, the reference position).

The embodiment of the driving assistance apparatus according to the present disclosure has been described; however, the present disclosure is not limited to the above-described embodiment, and various modifications are possible without departing from the scope of the disclosure. For example, in the present embodiment, the first sensor device is the radar apparatus 30 (namely, the millimeter-wave radar apparatus). However, the first sensor device may be an apparatus different from the millimeter-wave radar apparatus. Specifically, the first sensor device may be an apparatus having the reference axis for specifying the position of an object such as a LiDAR (Light Detection and Ranging) apparatus and a camera apparatus other than the camera apparatus 40.

In addition, the ECU 20 according to the present embodiment executes the collision alert processing as the driving assistance processing. However, the ECU 20 may execute processing different from the collision alert processing as the driving assistance processing. For example, the driving assistance processing may be “collision avoiding processing” for automatically generating brake force at the vehicle 10 in addition to the collision alert processing, or “cruise control processing” for automatically controlling the acceleration of the vehicle 10 such that the inter-vehicular distance between the vehicle 10 and another vehicle travelling at a position in front of the vehicle 10 detected by the radar apparatus 30 coincides with a predetermined target distance. Furthermore, the driving assistance processing may be processing for controlling the steering angle and the acceleration of the vehicle 10 such that the vehicle 10 travels on (along) a preconfigured (preset) route automatically.

In addition, the ECU 20 according to the present embodiment obtains the correction angle Δθ by executing the correction angle obtaining processing, and obtains the first vehicle relative position data (namely, the longitudinal base point difference Δx and the lateral base point difference Δy of the radar detected object) on the basis of that correction angle Δθ. However, the radar apparatus 30 may execute these processing in place of the ECU 20. In this case, the radar apparatus 30 (radar control section 33) may receive, from the camera apparatus 40, the camera detected position (Dc, θc) related to the optical target benchmark point Ptc of the optical target 71, and obtain the correction angle Δθ on the basis of that camera detected position. For example, in this case, the radar control section 33 stores that correction angle Δθ in a non-volatile memory included in the radar control section 33. Furthermore, in this case, the radar control section 33 may obtain the first vehicle relative position data on the basis of the correction angle Δθ stored in the radar control section 33 and the radar detected position (Dr, θr), and send that first vehicle relative position data to the ECU 20.

Alternatively, the correction angle obtaining processing may be executed by a processing apparatus other than the ECU 20. For example, when an operator performs the correction angle obtaining operation of the radar apparatus 30, the operator may cause a “vehicle maintenance terminal” which is temporarily connected to the radar apparatus 30 and the camera apparatus 40 to execute the correction angle obtaining processing. In this case, for example, the vehicle maintenance terminal is a general-purpose computer into which programs for vehicle maintenance have been installed. In addition, the correction angle Δθ which is obtained by the vehicle maintenance terminal may be registered to the ECU 20 (namely, may be written to the non-volatile memory of the ECU 20) via communication between the vehicle maintenance terminal and the ECU 20. In another case, the operator may operate the display 51 as the touch panel so as to register (input), to the ECU 20, the correction angle Δθ displayed on a display of the vehicle maintenance terminal.

Similarly, the camera axis adjustment processing executed by the ECU 20 according to the present embodiment may be executed by a vehicle maintenance terminal. In this case, when an operator performs the camera axis adjustment operation, the operator may cause the vehicle maintenance terminal temporarily connected to the camera apparatus 40 to display the lateral distance Dy related to the optical target benchmark point Ptc of the target section 61. In this case, the vehicle maintenance terminal may be configured to display, on its display, the lateral distance Dy related to the optical target benchmark point Ptc of the target section 61 obtained by the camera apparatus 40 which is temporarily connected to that terminal.

In addition, in the present embodiment, the radar apparatus 30 (namely, the first sensor device) is disposed at the center of the front end of the vehicle 10 and the camera apparatus 40 (namely, the second sensor device) is disposed at the position from which an object(s) in the camera detecting region lying in front of the vehicle 10 can be captured as the front image. However, each of the radar apparatus 30 and the camera apparatus 40 may be disposed at a position different from the above-described position. For example, the first sensor device may be disposed at the rear end of the vehicle 10. In this case, the second sensor device may be disposed inside the vehicle compartment of the vehicle 10 such that the second sensor device can capture an image of an object(s) behind the vehicle 10.

In addition, the vehicle 10 may be equipped with two of the first sensor devices, and the correction angles Δθ obtained for each of the first sensor devices may be stored in the non-volatile memory of the ECU 20 respectively. In this case, the first sensor devices may be disposed at each of the right front end and the left front end of the vehicle 10.

What is claimed is:

1. A driving assistance apparatus comprising:
a first sensor device, including a first detecting section placed at a predetermined first installation position of a vehicle, and configured to obtain first position data indicative of a position of a first object with respect to said first detecting section, said first object being an object present in a first detection region around said vehicle, and said first position data including a combination of a distance between said first detecting section and said first object and an angle formed between a straight line connecting said first detecting section and said first object and a first sensor reference axis extending from said first detecting section to a first predetermined direction;
a second sensor device, including a second detecting section placed at a predetermined second installation position of said vehicle, and configured to obtain second vehicle relative position data indicative of a position of a second object with respect to said vehicle, said second object being an object present in a second detection region around said vehicle, and said second detection region including an overlapping detecting region where said first detection region and said second detection region overlap each other; and
a control unit implemented by at least one programmed processor and configured to:
assist driving of said vehicle utilizing first vehicle relative position data indicative of the position of said first object with respect to said vehicle, said first vehicle relative position data being determined on the basis of said first position data obtained by said first sensor device;
start to execute correction angle obtaining processing to obtain an correction angle on the basis of a combination of said first position data obtained by said first sensor device for a first target as a reference object and said second vehicle relative position data obtained by said second sensor device for said first target when it is determined that an operator performs a predetermined correction angle obtainment starting operation, said correction angle being an angle formed between a vehicle reference axis defined based on said vehicle and said first sensor reference axis; and
obtain said first vehicle relative position data for an object present in said first detection region on the basis of a combination of said first position data for that object obtained by said first sensor device and said correction angle obtained through said correction angle obtaining processing in a predetermined period other than a period in which said correction angle obtaining processing is being executed.

2. The driving assistance apparatus according to claim 1, wherein, said second sensor device is configured to:
obtain second position data including a combination of a distance between said second detecting section and said second object and an angle formed between a straight line connecting said second detecting section and said second object and said vehicle reference axis; and
obtain said second vehicle relative position data on the basis of said second position data and a position of said second installation position with respect to said vehicle.

3. The driving assistance apparatus according to claim 2, wherein
said first sensor device is a radar apparatus comprising:
a radar transmission section which is a part of said first detecting section and is configured to transmit an electromagnetic wave to said first detection region;
a radar reception section which is a part of said first detecting section and is configured to receive an electromagnetic wave; and
a radar control section configured to obtain said first position data on the basis of said transmitted electromagnetic wave and said received electromagnetic wave;
said first detecting section is disposed at a center of a front end of said vehicle in a lateral direction, and
said second sensor device is a camera apparatus comprising:
an image obtaining section which is placed, as said second detecting section, at said second installation position, and is configured to obtain image data by capturing an image containing an object present in said second detection region, said second installation position being a predetermined position on a cabin side of a front windshield of said vehicle; and
an image processing section configured to obtain, as image position data, on the basis of said image data, a combination of a distance between said second detecting section and said second object and an angle formed between a straight line connecting said second detecting section and said second object and a second sensor reference axis extending from said second detecting section to a second predetermined direction with respect to said image processing section, and to treat said image position data as said second position data when said image obtaining section has been fixed to said vehicle such that said second sensor reference axis is parallel to a vehicle longitudinal axis extending in a longitudinal direction of said vehicle, said vehicle longitudinal axis serving as said vehicle reference axis.

4. An adjusting method for the driving assistance apparatus according to claim 1 comprising:
placing said first target at a position in said overlapped detecting region;
letting said control unit start to execute said correction angle obtaining processing by performing said correction angle obtainment starting operation; and
storing said correction angle obtained as a result of said correction angle obtaining processing into a readable and writable storage device.

5. An adjusting method of the driving assistance apparatus according to claim 3 comprising:
placing a second target at a center of a front end of said vehicle in the lateral direction, said second target being used for adjusting an axis direction of said second sensor reference axis;
letting said second sensor device obtain said second position data for said second target and adjusting a direction of said second detecting section such that the position of said second target indicated by said second position data coincides with a predetermined position, to thereby let said second sensor reference axis parallel to said vehicle longitudinal axis;
placing said first target at a position in said overlapped detecting region;
letting said control unit start to execute said correction angle obtaining processing by performing said correction angle obtainment starting operation; and
storing said correction angle obtained as a result of said correction angle obtaining processing into a readable and writable storage device.
